(19) United States
(12) Patent Application Publication
(10) Pub. No.: US 2025/0296409 A1
(43) Pub. Date: Sep. 25, 2025

(54) FLUSH VEHICLE DOOR HAVING A DETACHABLE SLIDER FIXING RAIL AND A METHOD OF ASSEMBLING A FLUSH DOOR

(71) Applicants: HYUNDAI MOTOR COMPANY, Seoul (KR); KIA CORPORATION, Seoul (KR); SUNG WOO HITECH CO., LTD., Busan (KR); KCC GLASS Corporation, Seoul (KR)

(72) Inventors: Jea-Hong Kim, Hwaseong-si (KR); Sang-Hyun Lee, Hwaseong-si (KR); Hyung-Sik Choi, Hwaseong-si (KR); Kyu-Yeol Lee, Sejong-si (KR); Sang-Hyun Na, Hwaseong-si (KR); Min-Su Kim, Seoul (KR); Jun-Ho Bae, Busan (KR)

(73) Assignees: HYUNDAI MOTOR COMPANY, Seoul (KR); KIA CORPORATION, Seoul (KR); SUNG WOO HITECH CO., LTD., Busan (KR); KCC GLASS Corporation, Seoul (KR)

(21) Appl. No.: 18/949,642

(22) Filed: Nov. 15, 2024

(30) Foreign Application Priority Data
Mar. 20, 2024 (KR) 10-2024-0038268

(51) Int. Cl. B60J 1/17; B60J 10/76; B60J 10/79

(52) U.S. Cl. CPC B60J 1/17; B60J 10/76; B60J 10/79

(57) ABSTRACT

A flush door for a vehicle has a detachable slider fixing rail. The flush door includes a door body in white (BIW) having a door frame; a door module mounted on the door frame; a glass configured to be moved up and down by the door module; and a slider. The slider has a movement guide including a connection part connected to the glass and has a body part located in a U-shaped section defined by a rail and a garnish plate. The rail and the garnish plate are configured separately and the garnish plate covers an open section of the rail and guides movement of the slider.

### CROSS-REFERENCE TO RELATED APPLICATION

This application claims priority to Korean Patent Application No. 10-2024-0038268, filed on Mar. 20, 2024, which is incorporated herein by reference in its entirety.

### BACKGROUND OF THE DISCLOSURE

### Field of the Disclosure

The present disclosure relates to a flush door for a vehicle, and more specifically, to a method of assembling a flush door for a vehicle, where the flush door is assembled by being inserted from the outside to the inside while a slider is fixed by a separate rail.

### Description of Related Art

In general, a flush door for a vehicle is implemented in a structure without a step or offset between a glass (e.g., a window or door glass) and a garnish by attaching a glass slider to a door glass or window included in the door of a vehicle.

In particular, the flush door may be implemented as a modular flush door by modularizing a rail, a glass run (e.g., a glass run channel), and a garnish, which are components of the glass slider assembly for a door glass. For example, a modular flush door may include a modular rail, a modular glass run, and a modular garnish.

Therefore, the modular flush door provides an advantage in that the rail, the glass run, and the garnish that restrain the glass slider assembly may be inserted in an in-line manner in a module state during the assembly process.

However, the modular flush door has a number of structural defects to be solved.

For example, as a first structural defect, it is difficult to assemble the glass slider assembly for the door glass due to an integrated structure of the glass run and the rail. As a second structural defect, production/management and assemblability are required to assemble the modular structure of the glass run and the garnish, thereby excessively increasing the cost compared to the general door structure. As a third structural defect, the glass slider is restricted to the glass run, thereby causing the excessive movement or distribution of the door glass. As a fourth structural defect, it is not possible to assemble the glass slider in an in-line manner. As a fifth structural defect, since the glass slider is a movement trajectory toward the glass run, it is difficult to secure the fixability of the door glass.

### SUMMARY OF THE DISCLOSURE

Therefore, in light of the Background section the present disclosure is directed to providing a flush door for a vehicle, the flush door having a detachable slider fixing rail, and to a method of assembling the flush door. The flush door includes a slider for guiding a glass to move up and down. The slider is surrounded by a U-shaped cross-section formed of a rail, which is disposed at an internal location of a door frame, and a garnish, which is disposed at an external location. Specifically, the rail and the garnish overlap each other to enable an in-line assembly through a separated structure of the rail and the garnish (which form the “U” shaped cross-section. In particular, the separated (e.g., spaced apart) structure of the rail and the garnish enables component assembly from an outdoor side to an indoor side (of the door) in the order of a rail, the glass and slider, a garnish plate, and the garnish. Assemblability may thereby be improved without requiring component modularization equipment and module installation labor-saving equipment, thus reducing the cost of the flush vehicle door and a vehicle including the flush vehicle door.

A flush door having a detachable slider fixing rail according to the present disclosure is provided for achieving at least the above described objects. The flush door includes a door body in white (BIW) with a door frame, a door module mounted on the door frame, a glass configured to be moved up and down by the door module, and a slider. The slider includes a movement guide having a connection part connected to the glass and a body part located in a U-shaped section formed by a rail and a garnish plate. Tthe rail and the garnish plate are configured separately, and the garnish plate covers an open section of the rail and guides movement of the slider.

The rail may be located inside the door frame, and the garnish plate may cover the open section of the rail outside the door frame.

The rail, the slider, and the garnish plate may be made of a hard material.

The rail and the garnish plate may form the U-shaped section in an overlapping section in which the open section of the rail is covered by the garnish plate while the rail and the garnish plate are spaced apart from one another. The U-shaped section may support a reaction force of the door BIW generated by the upward/downward movements of the glass.

A micro clearance structure may be included in the U-shaped section, and the micro clearance structure may constrain the glass at a location according to the upward/downward movements of the glass.

A glass run inner lip may be assembled to the rail, and the glass run inner lip may form an airtight seal at an inside of the glass.

The glass may be connected to the connection part by adhesion of a sealant.

The body part of the slider may absorb distribution, i.e., movement, of the U-shaped section. The body part may absorb the distribution with flexibility of a tension part. The body part may have an entry part provided on upper and lower portions thereof. The entry part may have a circular structure and suppress the occurrence (e.g., generation) of noise during the upward/downward movements of the slider.

Grease may be applied between the open section of the rail and the body part of the slider. The grease may compensate for friction due to the upward/downward movements of the slider.

The glass and the slider may be connected by bonding the sealant to the connection part.

The garnish of the door BIW may be configured by coupling the garnish plate to the garnish cove., A glass run outer lip assembled to the garnish cover may form an airtight seal at an outside of the glass.

The door frame may be provided with a location hole and a bolt hole, the rail may be constrained by coupling a guide pin with the location hole, and the garnish plate may be constrained by coupling an insert bolt and the bolt hole.

A nut may be applied to a fixing portion of the garnish plate, a screw may be applied to a fixing portion of the rail, and a pad may be applied to a contact portion of the rail.

The door BIW may be configured by covering an inner panel cover by the coupling the door frame and a door inner panel. An inner panel cover lip assembled to the inner panel cover may form an airtight seal at an inside of the glass.

In addition, a method of assembling a flush door having a detachable slider fixing rail according to the present disclosure for achieving at least the above described objects is provided. The method includes inserting a rail into a door frame, coupling a glass run to the rail outside a door body in white (BIW), mounting a door module on the door frame inside the door BIW, mounting a slider and an integrated glass on the door module outside the door BIW, and coupling the slider to the rail. The method further includes forming a U-shaped section by a garnish plate, among a garnish cover and the garnish plate of a garnish, and a glass run inner lip that cover an open section of the rail outside the door BIW. The method also includes forming an airtight seal at an inside of the glass by the glass run inner lip, coupling the garnish cover to the garnish plate, coupling a door inner panel to the door frame, and covering the door inner panel by an inner panel cover inside the door BIW.

The method may include constraining the rail and the door frame by a guide pin of the rail and a location hole of the door frame. The method may also include constraining the garnish plate and the door frame by an insert bolt of the garnish plate and a bolt hole of the door frame.

The glass run inner lip may be assembled to the rail inside the glass. An inner panel cover lip may be applied to the inner panel cover to form an airtight seal inside the glass. The garnish cover may be bonded by a double-sided tape to the garnish plate, a pad may be applied to prevent noise with the rail, a nut may be applied to be fixed to the garnish plate, and a screw may be applied to be fixed to the rail.

The flush vehicle door having a detachable slider fixing rail of the present disclosure implements the following operations and effects.

First, it is possible to improve assemblability compared to the conventional module type production processes by sequentially inserting and assembling the rail, the glass slider, and the garnish plate and cover from the outdoor side to the indoor side.

Second, it is possible to reduce the cost of modularizing components and investing in production facilities for module assembly, thereby minimizing the increase in cost and securing competitiveness in terms of the product cost.

Third, since the rail and the garnish plate, which are the parts of the slider for moving up and down, are made of aluminum rigid body, it is possible to easily secure upward/downward movement performance with superior wear resistance performance compared to conventional hard materials.

Fourth, by implementing the structure that minimizes the location and assembly position distribution of the glass and the garnish plate, it is possible to solve the tilting problem that occurs when the glass moves up and down.

Fifth, since only minimal changes are required in the conventional production process, the present disclosure may be applied without modifying the conventional production line.

### BRIEF DESCRIPTION OF THE DRAWINGS

FIG. 1 is an exploded view of a flush door having a detachable slider fixing rail according to the present disclosure.

FIG. 2 is a partial view of a flush door and a cross-sectional view taken along line A-A of a garnish constituting a B-pillar portion in the flush door according to the present disclosure.

FIG. 3 shows front and side views of a glass of a slider coupled in a flush door according to the present disclosure.

FIG. 4 shows an exploded view of a rail and a door frame of a garnish in a flush door according to the present disclosure.

FIG. 5 is a flowchart of a method of assembling a flush door having a detachable slider fixing rail according to the present disclosure.

FIG. 6 shows an exploded view of a flush door and a cross-section taken along line K-K of an assembled state of components of the flush door according to the present disclosure.

FIG. 7 shows a vehicle to which the flush door having the detachable slider fixing rail according to the present disclosure is applied.

### DESCRIPTION OF SPECIFIC EMBODIMENTS

Hereinafter, embodiments of the present disclosure are described in detail with reference to the accompanying drawings. The embodiments described herein are merely examples and may be implemented in various different forms by those of ordinary skill in the art to which the present disclosure pertains. Thus, the present disclosure is not limited to the embodiments disclosed herein.

When a component, device, element, or the like of the present disclosure is described as having a purpose or performing an operation, function, or the like, the component, device, or element should be considered herein as being “configured to” meet that purpose or perform that operation or function.

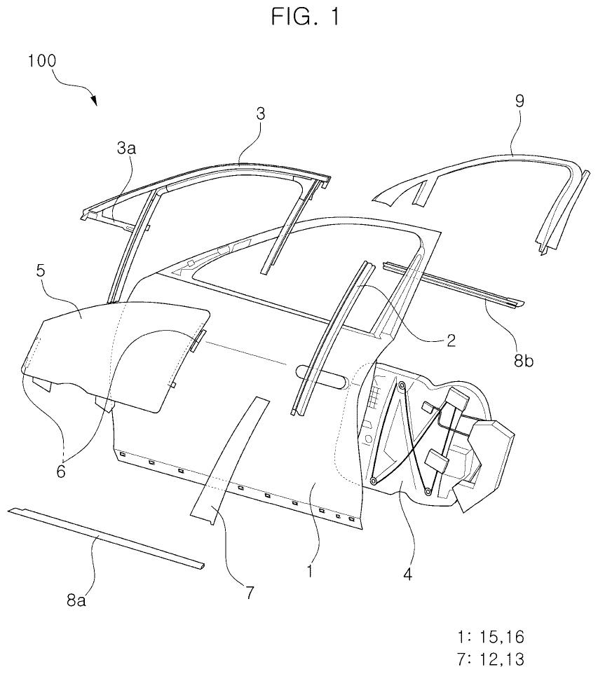

Referring to FIGS. 1-4, a flush door 100 includes, as components, a door body in white (BIW) 1, a rail 2, a glass run 3, a door module 4, a door glass or window, i.e., a glass 5, a slider 6, a trim piece, i.e., a garnish 7, an outer belt 8a, an inner belt 8b, and an inner panel cover 9. The flush door 100 further includes, as air-tightness members or components, a sealant 10, a glass run outer lip 11, a glass run inner lip 14, a pad 17, and an inner panel cover lip 18. The flush door 100 further includes, as fastening components, a nut 19 and a screw 20.

In particular, the flush door 100 implements a flush structure without a step or offset between a glass 5 and a garnish 7. The flush door 100 defines an upward/downward or vertical movement guide of the slider 6 by separating a rail 2 located inside the door and a garnish plate 13 located on an outside of the door based on a position of the slider 6 on which the glass 5 operates. Therefore, separate modularization and equipment are not required compared to the conventional configuration in which a glass module in which a glass, rail, garnish cover, garnish plate, glass run inner lip, and glass run outer lip are integrated is mounted on a door frame 15. In particular, separate labor-saving equipment in a production line for mounting a glass module is also not required. Accordingly, costs can be saved in manufacturing of the flush door and the vehicle to which the flush door having a detachable slider fixing rail is coupled.

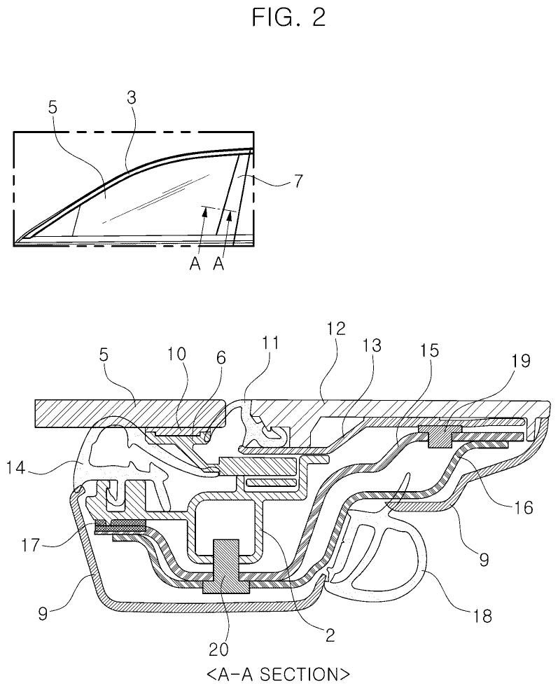

Referring to FIG. 2 together with FIG. 1, a detailed structure of components and assembled components of the flush door 100 is shown.

For example, the door BIW 1 is a door structure having an interior space for door components and having a top frame structure. The door BIW 1 has a door frame 15 and a door inner panel 16 therein. The door frame 15 has one side located on the rail 2 and another side located on a garnish cover 12. The door inner panel 16 is added to the door frame 15. Both sides of the door inner panel 16 may be fixed to the door frame 15 by welding.

In particular, the door BIW 1 blocks external exposure by having a door module 4 embedded therein using a built-in door component space. The door BIW 1 couples and externally exposes the glass run 3 and the garnish 7 (i.e., the garnish cover 12) using the top frame structure.

For example, the rail 2 is made of a hard material (e.g., a rigid body). An air-tightness part extends to one side of a quadrangular body so that a glass run inner lip 14 is fitted into or couple to the rail 2. An end or exposed edge of the slider 6 may be mounted by being inserted in an open section structure of the rail 2. The end of the slider may be mounted by an insertion part extending into the open section structure of the rail 2 disposed on the other side of the quadrangular body.

Therefore, the rail 2 has an open section structure and is supported by being fastened to the top frame structure of the door BIW 1 using hardware.

For example, the glass run 3 is configured integrally with a frame molding and a fixed glass 3a and is assembled to the top frame structure of the door frame 15 so that the glass 5 is mounted, and in particular, is fitted into the door frame 15 to fix the glass run 3 and the door frame 15 with a fastening portion holding one side. In this case, the glass run 3 may be assembled in a state of being supported by the door frame 15 and the door trim at some points on the outer surface thereof.

Therefore, the glass run 3 is mounted on the door BIW 1 on which the integrated structural rail 2 is assembled.

For example, the door module 4 includes a motor for generating an operating force that moves the glass 5 up and down. The operating force of the motor is transmitted to the slider 6, which is bonded to the glass 5, and the sealant 10 to move the glass 5 up and down relative to a U-shaped section formed by the rail 2 and the garnish plate 13.

For example, the glass 5 is formed as a coupling body with the slider 6 to move up and down and is mounted on the door module 4.

In particular, the slider 6 is located at both left and right sides of the glass 5.

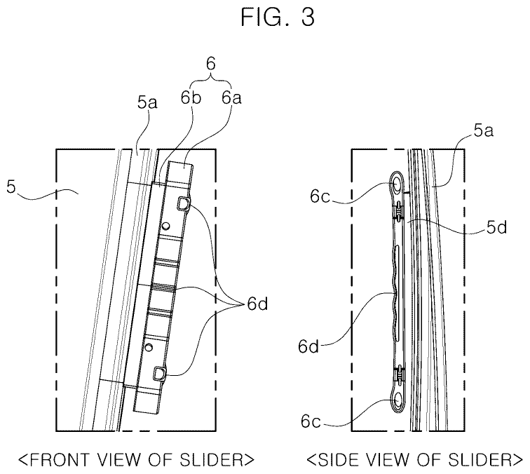

For example, the slider 6 is made of a hard (e.g., a rigid body) material, has one portion formed of an adhesive portion bonded to the glass 5 and the sealant 10 and the other portion formed of a fitting portion inserted into the open section structure of the rail 2. In one example, the slider 6 is configured as two sliders 6 provided at both left and right sides of the glass 5. In this case, one portion is a connection part 6b (see FIG. 3), and the other portion is a body part 6a (see FIG. 3).

In particular, the slider 6 includes a spring structure (i.e., a tension part 6d in FIG. 3). The spring structure absorbs the distribution of the U-shaped section within the U-shaped section formed by the rail 2 and the garnish plate 13. In this case, the distribution absorption is L-directional and T-directional locations of the upward and downward movement of the glass.

Therefore, the slider 6 is mounted on the open section structure of the rail 2, and grease is applied between the rail 2 and the slider 6 to compensate for the friction that occurs with the rail 2 when the slider 6 moves up and down together with the glass 5.

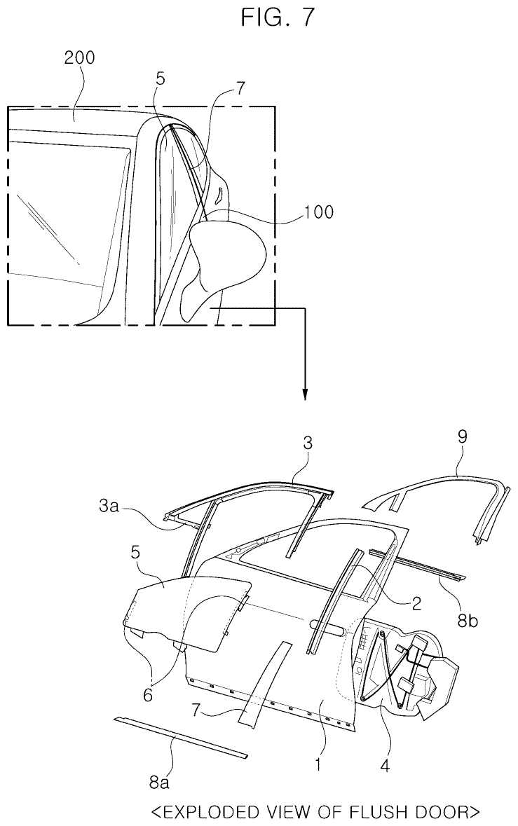

For example, the garnish 7 is fastened to the door BIW 1 using a bolt. Particularly, the garnish 7 is coupled to a B pillar frame of the frame structure of the door frame 15 and configured as a B pillar of a vehicle 200 (see FIG. 7).

To this end, the garnish 7 includes the garnish cover 12 coupled to the outside of the door frame 15 and formed as an externally exposed portion of the B pillar of the vehicle. The garnish plate 13 is coupled to the inside of the door frame 15 and made of the hard (e.g., hard body) material which covers the inside of the B pillar. The garnish cover 12 and the garnish plate 13 support a reaction force toward an outside of the door BIW 1 generated while the coupling body of the glass 5 and the slider 6 move up and down, thereby preventing a change in location of the glass 5. In this case, the location change prevention is the L directional location.

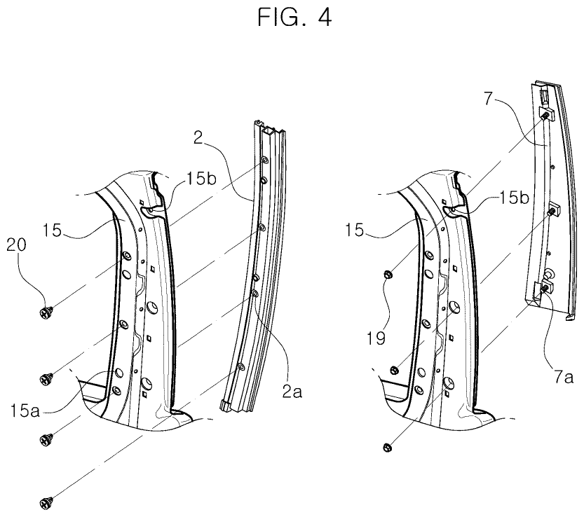

In particular, the garnish plate 13 has a micro clearance structure (i.e., an insert bolt 7a and a nut 19 in FIG. 4) provided on the U-shaped section covering the open section of the rail 2. The garnish plate 13 and/or the micro clearance structure, specifically, constrain the glass 5 moving up and down to prevent shaking. In this case, the constraint is the fore-aft, lengthwise, or L-directional and side-to-side, widthwise, or T-directional locations (relative to the vehicle) of the upward and downward movements of the glass.

Therefore, the garnish 7 forms the U-shaped section by covering the open section of the rail 2 with the garnish plate 13.

For example, an outer belt 8a is attached to the outside of the door BIW 1 and an inner belt 8b is attached to the inside of the door BIW 1, The outer belt 8a and the inner belt 8b are configured as a boundary area of the top frame structure of the door frame 15 of the door BIW 1.

For example, an inner panel cover 9 is added to the inside of the door BIW 1and covers a mounting hole or a fastening hole portion (e.g., a fastening portion of the nut/screw) of the door frame 15 and the door inner panel 16 to prevent external exposure. Thus, the inner panel cover 9 serves to cover the hole portion to prevent the hole portion from being visible from inside the vehicle (i.e., a vehicle interior).

In particular, the inner panel cover 9 is provided with a lip insertion portion at a predetermined section or location, and the inner panel cover lip 18 is assembled.

For example, the sealant 10 is applied to an adhesive portion of the slider 6 to fixedly bond the slider 6 to the glass 5. In this case, the sealant 10 is applied to each of the two sliders 6 provided at both left and right sides (i.e., forward and rearward ends or edges) of the glass 5.

For example, the glass run outer lip 11 forms an assembly of the garnish 7 together with the garnish cover 12 and the garnish plate 13 and is assembled to the garnish cover 12 to form an airtight seal between the garnish cover 12 and the glass 5 at an outside or edge of the glass 5. The glass run inner lip 14 is assembled to an airtight portion, which is an extension of the rail 2, to form an airtight seal at an inside of the glass 5. The inner panel cover lip 18 is assembled to the lip insertion portion of the inner panel cover 9 to form an airtight seal inside the glass 5.

For example, the pad 17 is added to the coupling portion of the door frame 15 and the rail 2 between the rail 2 and the door frame 15 to prevent noise with the frame due to hardware fastening of the rail 2 and the door frame 15.

For example, the nut 19 is fastened to the insert bolt 7a (see FIG. 3) of the garnish 7 (i.e., the garnish plate 13) to couple the garnish plate 13 to the door frame 15. The screw 20 is fastened to an overlapping portion of the door frame 15 and the door inner panel 16 and coupled to the quadrangular body of the rail 2 to fix the door frame 15 to the door inner panel 16.

In addition, referring to FIGS. 3 and 4, the slider coupling structure between the glass 5 and the slider 6, the rail coupling structure between the door frame 15 and the rail 2, and the coupling structure between the door frame 15 and the garnish 7 (i.e., the garnish plate 13) are shown.

Referring to FIG. 3, the slider coupling structure includes a slider installation part 5b provided on the glass frame 5a, which is an edge of the glass 5 and includes the connection part 6b (i.e., the adhesive portion) provided on the body part 6a of the slider 6.

Therefore, when the glass 5 and the slider 6 are coupled, the glass 5 and the slider 6 are coupled and fixed by the adhesion of the sealant 10 in a state in which the connection part 6b is added to the slider installation part 5b.

In particular, the slider 6 includes an entry part 6c and a tension part 6d on the body part 6a having a spring structure that overlaps while being coupled to the rail 2 by being inserted into the insertion portion of the open section structure of the rail 2. The entry part 6c forms both circular ends (i.e., upper and lower portions) of the body part 6a to prevent any noise when the slider 6 moves up and down in the rail 2.

In addition, the tension part 6d has both a plurality of upper convex shapes in a nodular structure protruding from a middle portion of the body part 6a to an upper surface of the body and side convex shapes protruding from the upper and lower portions of the body part 6a to the side surface of the body to absorb distribution or movement that may occur with body elasticity. In this case, the distribution absorption of the tension part is the L-directional and T-directional locations of the upward and downward movements of the glass.

Referring to FIG. 4, the rail coupling structure is composed of a guide pin 2a protruding from the rail 2 and a location hole 15a perforated in the door frame 15. The garnish coupling structure is composed of the insert bolt 7a protruding from the garnish plate 13 of the garnish 7 and a bolt hole 15b perforated into the door frame 15.

Therefore, when the rail 2 and the door frame 15 are coupled, the guide pin 2a is fitted into the location hole 15a so that the rail 2 is constrained relative to the door frame 15 and so that the rail 2 and the door frame 15 are fastened using the screw 20.

In addition, when the garnish plate 13 and the door frame 15 are coupled, the insert bolt 7a passes through the bolt hole 15b and is screw-fastened to the nut 19 so that the garnish 7 is constrained relative to the door frame 15 in a state in which the garnish plate 13 and the door frame 15 are screw-fastened.

As described above, both the rail 2 and the garnish plate 13, which determine the upward/downward trajectory of the glass, are mounted on the door frame 15, and locations thereof are constrained to provide a structure advantageous for unwanted movement or distribution management.

Meanwhile, FIG. 7 shows the vehicle 200 to which the flush door 100 is applied.

As shown, the vehicle 200 includes the flush door 100. The flush door 100 implements a flush structure without a step or offset between the glass 5 and the garnish 7.

Therefore, the flush door 100 is the flush door 100 described with reference to FIGS. 1-4 and implements a flush structure without a step or offset between the glass 5 and the garnish 7. The rail 2 is located inside relative to the slider 6 by which the glass 5 moves and the garnish plate 13 is located outside relative to the slider 6. The rail 2 and the garnish plate 13 are spaced apart or separated to form the upward and downward movement structure of the slider 6 so that the glass 5 moves up and down.

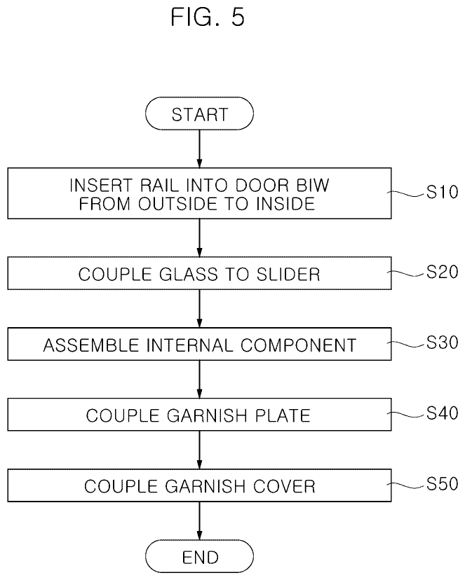

Meanwhile, FIG. 5 shows a method of assembling the flush door having a detachable slider fixing rail. In this case, a direction in which the door BIW 1 is visible from the outside is defined as the outside of the door. A direction in which the door BIW 1 is visible from the inside is defined as the inside of the door.

As shown, the method of assembling the flush door includes a door BIW and rail inserting operation of assembling the rail 2 and the glass run 3 from the outside of the door BIW 1 (operation S10). The method also includes an operation of coupling the glass 5 and the slider 6 to the door module 4 from the outside of the door BIW 1 after the door module 4 is mounted inside the door BIW (operation S20). The method also includes an internal component assembling operation (operation S30), an operation of coupling the garnish plate 13 of the garnish 7 to the glass run inner lip 14 from outside the door BIW 1 (operation S40), and an operation of coupling the garnish cover 12 of the garnish 7 to the inner panel cover 9 inside the door BIW 1 (operation S50).

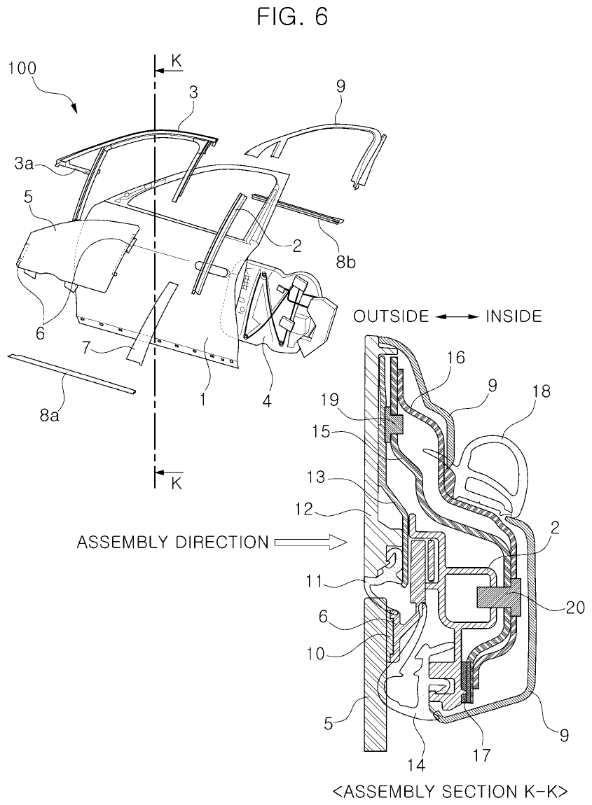

Referring to FIG. 6, the door BIW and rail inserting operation (S10) includes inserting the rail 2 into the top frame structure of the door frame 15 from the outside to the inside of the door BIW 1 and then supporting the same by fastening hardware. Additionally, the door BIW and rail inserting operation (S10) includes mounting the integrated glass run 3 of the frame molding and the fixed glass 3a on the door frame 15 of the door BIW 1 on which the rail 2 is mounted.

In particular, the rail 2 serves to constrain the guide pin 2a in the location hole 15a of the door frame 15 as shown in FIG. 4.

In addition, a pad 17 is attached to prevent any noise with the frame when hardware is fastened between the rail 2 and the door frame 15.

Next, the glass and slider coupling operation (S20) includes mounting or coupling the slider 6 and the integrated glass 5 bonded with the sealant 10 to the door module 4 mounted inside the door frame 15. The operation (S20) also includes mounting the slider 6 on the open section structure of the rail 2.

In addition, grease is applied to compensate for friction when the slider 6 is inserted into the open section structure of the rail 2.

In addition, the internal component assembling operation (S30) includes mounting each of the outer belt 8a and the inner belt 8b on the door frame 15 of the door BIW 1, assembling the glass run inner lip 14 in the fastening groove of the rail 2, and assembling the inner panel cover lip 18 on the inner panel cover 9. The operation (S30) also includes fastening the rail 2 to the door frame 15 using the screw 20 and fastening the rail 2 and the door frame 15 using the screw 20 to fix the rail 2 to the door frame 15.

As described above, the internal component assembling operation (S30) is an operation for mounting the outer belt 8a and the inner belt 8b, the glass run inner lip 14, the inner panel cover lip 18, the screw 20, and the like. However, in the actual assembly process, the components may separately perform any one of the door BIW and rail inserting operation (S10), the glass and slider coupling operation (S20), the garnish plate coupling operation (S40), and the garnish cover coupling operation (S50).

Therefore, the internal component assembling operation (S30) is shown as a separate process operation but may be described through any one of the door BIW and rail inserting operation (S10), the glass and slider coupling operation (S20), the garnish plate coupling operation (S40), and the garnish cover coupling operation (S50).

Specifically, in the garnish plate coupling operation (S40) and the garnish cover coupling operation (S50), the glass run outer lip 11, garnish cover 12, and/or garnish plate 13 are configured as the assembly of the garnish 7 and are finished by assembling the glass 5, then cover the rail 2, and being fastened to the door BIW 1 using hardware.

In particular, the assembly of the garnish 7 is implemented by assembling the glass run outer lip 11 between the garnish cover 12 and the garnish plate 13.

For example, in the garnish plate coupling operation (S40), in a state in which the glass 5 is assembled, the garnish plate 13 is fastened to the door frame 15 of the door BIW 1 using hardware to form the U-shaped section by covering the open section of the rail 2. Also, the glass run inner lip 14 is assembled in the fastening groove provided in the airtightness part of the rail 2.

Therefore, the garnish plate 13 may generate the support force to the inside of the vehicle. As shown in FIG. 3, the constraint of the garnish 7 to the door frame 15 may be implemented by the insert bolt 7a passing through the bolt hole 15b and screw-fastened to the nut 19.

For example, in the garnish cover coupling (S50), the garnish cover 12 is bonded to the garnish plate 13 using a double-sided tape, the inner panel cover 9 is coupled to the door BIW 1, and the inner panel cover lip 18 is assembled to the inner panel cover 9. Thus, the door BIW 1 covering the door frame 15 and the door inner panel 16 is completely assembled.

Therefore, it can be seen that in the method of assembling the flush door, it is possible to significantly improve assemblability compared to the conventional module type method of assembling the components because the components of the door BIW 1 are inserted from the outside to the inside to assemble the flush door 100 in the assembly process of the flush door 100.

In addition, since the method of assembling the flush door requires a minimal change from the conventional production process, the method may be applied without modifying the conventional production line. In particular, the method of assembling a flush door described herein can reduce modularization costs incurred from the conventional module type productions lines and reduce investment costs in production facilities for module assembly, thereby securing competitiveness in terms of product costs.

As described above, in the flush vehicle door having the detachable slider fixing rail and the method of assembling the flush door, the slider 6 for guiding the glass 5 mounted on the door module 4 of the door BIW 1 to move up and down is surrounded by the U-shaped section formed of the rail 2, which is disposed at an internal location of the door frame 15, and the garnish plate 13, which is disposed at an external location of the door frame. As a result, in-line assembly through a separation structure of the rail and the garnish is enabled. In particular, the above described structure enables the component assembly from an outdoor side or outside to an indoor side or inside in the order of a rail, the glass and slider, a garnish plate, and the garnish through the separation structure of the rail and the garnish, thereby improving assemblability in the distinct flush door assembly method compared to the conventional module assembly method.

The present disclosure has been described with reference to the example embodiments and the drawings, but the present disclosure is not limited thereby. The present disclosure may be carried out in various forms by those having ordinary skill in the art, to which the present disclosure pertains, within the technical spirit of the present disclosure and the scope of equivalents to the appended claims.

What is claimed is:

1. A flush door for a vehicle, the flush door comprising:
a door body in white (BIW) having a door frame;
a door module mounted on the door frame;
a glass configured to be moved up and down by the door module; and
a slider including a movement guide including a connection part connected to the glass and a body part located in a U-shaped section formed by a rail and a garnish plate,
wherein the rail and the garnish plate are configured separately, and
wherein the garnish plate covers an open section of the rail and guides movement of the slider.

2. The flush door of claim 1, wherein the rail, the slider, and the garnish plate are made of a hard material.

3. The flush door of claim 1, wherein the rail and the garnish plate form the U-shaped section in an overlapping section in which the open section of the rail is covered by the garnish plate while the rail and the garnish plate are spaced apart from one another.

4. The flush door of claim 3, wherein the U-shaped section supports a reaction force of the door BIW generated by upward/downward movements of the glass.

5. The flush door of claim 3, wherein a micro clearance structure is included in the U-shaped section, and wherein the micro clearance structure constrains the glass at a location according to the upward/downward movement of the glass.

6. The flush door of claim 1, wherein a glass run inner lip is assembled to the rail, and wherein the glass run inner lip forms an airtight seal at an inside of the glass.

7. The flush door of claim 1, wherein the glass is connected to the connection part by adhesion of a sealant.

8. The flush door of claim 1, wherein the body part of the slider absorbs a distribution of the U-shaped section.

9. The flush door of claim 8, wherein the body part absorbs the distribution of the U-shaped section with flexibility of a tension part.

10. The flush door of claim 8, wherein the body part has an entry part provided on upper and lower portions thereof, and wherein the entry part has a circular structure and suppresses the occurrence of noise during the upward/downward movements of the slider.

11. The flush door of claim 1, wherein grease which compensates friction due to the upward/downward movements is applied between the open section of the rail and the body part of the slider, and wherein the glass and the slider are connected by bonding the sealant to the connection part.

12. The flush door of claim 1, wherein the garnish of the door BIW is configured by coupling the garnish plate to the garnish cover, and wherein a glass run outer lip assembled to the garnish cover forms an airtight seal at an outside of the glass.

13. The flush door of claim 1, wherein:
the door frame is provided with a location hole and a bolt hole;
the rail is constrained by coupling a guide pin with the location hole; and
the garnish plate is constrained by coupling an insert bolt and the bolt hole.

14. The flush door of claim 1, wherein:
a nut is applied to a fixing portion of the garnish plate;
a screw is applied to a fixing portion of the rail; and
a pad is applied to a contact portion of the rail.

15. The flush door of claim 1, wherein the door BIW is configured by covering an inner panel cover by the coupling the door frame and a door inner panel, and wherein an inner panel cover lip assembled to the inner panel cover forms an airtight seat at an inside the glass.

16. A method of assembling a flush door having a detachable slider fixing rail, the method comprising:
inserting a rail into a door frame and coupling a glass run to the rail outside a door body in white (BIW);
mounting a door module on the door frame inside the door BIW;
mounting a slider and an integrated glass on the door module outside the door BIW;
coupling the slider to the rail;
forming a U-shaped section by a garnish plate, among a garnish cover and the garnish plate of a garnish, and a glass run inner lip that cover an open section of the rail outside the door BIW;
forming an airtight seal at an inside of the glass by the glass run inner lip;
coupling the garnish cover to the garnish plate;
coupling a door inner panel to the door frame; and
covering the door inner panel by an inner panel cover inside the door BIW.

17. The method of claim 16, further comprising:
constraining the rail and the door frame by a guide pin of the rail and a location hole of the door frame, and
constraining the garnish plate and the door frame by an insert bolt of the garnish plate and a bolt hole of the door frame.

18. The method of claim 16, further comprising assembling the glass run inner lip to the rail inside the glass.

19. The method of claim 16, further comprising applying an inner panel cover lip to the inner panel cover to form an airtight seal inside the glass.

20. The method of claim 16, further comprising:
bonding the garnish cover using a double-sided tape to the garnish plate;
applying a pad to the door frame to prevent noise with the rail;
fixing a nut to the garnish plate; and
fixing a screw to the rail.
